(19) United States
(12) Patent Application Publication
(10) Pub. No.: US 2025/0378601 A1
(43) Pub. Date: Dec. 11, 2025

(54) ARTIFICIAL INTELLIGENCE LIFECYCLE GOVERNANCE SPHERICAL VISUALIZATION

(71) Applicant: INTERNATIONAL BUSINESS MACHINES CORPORATION, Armonk, NY (US)

(72) Inventors: Yi Yuan, Beijing (CN); Peng Hui Jiang, Beijing (CN); WeiFeng Zhang, Shenzhen (CN); Shun Xin Cao, Hefei (CN); An Qi Yu, Shanghai (CN); YU XIANG CHEN, Shanghai (CN)

(21) Appl. No.: 18/735,443

(22) Filed: Jun. 6, 2024

(51) Int. Cl. G06T 11/20; G06T 17/00; G06T 19/20

(52) U.S. Cl. CPC G06T 11/206; G06T 17/00; G06T 19/20; G06T 2200/24; G06T 2219/004; G06T 2219/2016

(57) ABSTRACT

In a first aspect of the invention, there is a computer-implemented method including: normalizing, by the processor set, an artificial intelligence model input data set; encoding, by the processor set, a data point of the data set; converting, by the processor set, the encoded data point into an angle on a spherical coordinate system to determine a basis vector direction for the data within the data set; generating, by the processor set, a basis vector including the encoded data point based on the angle and the normalizing; and generating, by the processor set, instructions to render a spherical model including the basis vector, wherein the instructions are configured to cause a client device to render the spherical model.

### BACKGROUND

Aspects of the present invention relate generally to artificial intelligence (AI) models and generating spherical visualizations.

AI model explainability is the ability to describe how AI models make decisions, including describing an appropriate understanding of the technology, development processes, and operational methods of its AI systems. AI model explainability may include the ability to explain the sources and triggers for decisions through transparent, traceable processes and auditable methodologies, data sources, and design procedure and documentation.

### SUMMARY

In a first aspect of the invention, there is a computer-implemented method including: normalizing, by a processor set, an artificial intelligence model input data set; encoding, by the processor set, a data point of the data set; converting, by the processor set, the encoded data point into an angle on a spherical coordinate system to determine a basis vector direction for the data within the data set; generating, by the processor set, a basis vector comprising the encoded data point based on the angle and the normalizing; and generating, by the processor set, instructions to render a spherical model comprising the basis vector, wherein the instructions are configured to cause a client device to render the spherical model.

In another aspect of the invention, there is a computer program product including one or more computer readable storage media having program instructions collectively stored on the one or more computer readable storage media. The program instructions are executable to: normalize an artificial intelligence model input data set; encode a data point of the data set; convert the encoded data point into an angle on a spherical coordinate system to determine a basis vector direction for the data within the data set; generate a basis vector comprising the encoded data point based on the angle and the normalizing; and generate instructions to render a spherical model comprising the basis vector, wherein the instructions are configured to cause a client device to render the spherical model.

In another aspect of the invention, there is a system including a processor set, one or more computer readable storage media, and program instructions collectively stored on the one or more computer readable storage media. The program instructions are executable to: normalize an artificial intelligence model input data set; encode a data point of the data set; convert the encoded data point into an angle on a spherical coordinate system to determine a basis vector direction for the data within the data set; generate a basis vector comprising the encoded data point based on the angle and the normalizing; and generate instructions to render a spherical model comprising the basis vector, wherein the instructions are configured to cause a client device to render the spherical model.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary method in accordance with aspects of the present invention.

FIG. 4 shows a block diagram of an exemplary environment in accordance with aspects of the present invention.

FIG. 5 shows a diagram of an exemplary method in accordance with aspects of the present invention.

FIG. 6A shows an example of a spherical model in accordance with aspects of the present invention.

FIG. 6B shows an example of a spherical model in accordance with aspects of the present invention.

FIG. 6C shows an example of a spherical model in accordance with aspects of the present invention.

FIG. 6D shows an example of a spherical model in accordance with aspects of the present invention.

FIG. 6E shows an example of a spherical model in accordance with aspects of the present invention.

FIG. 6F shows an example of a spherical model in accordance with aspects of the present invention.

FIG. 6G shows an example of a spherical model in accordance with aspects of the present invention.

FIG. 6H shows an example of a spherical model in accordance with aspects of the present invention.

FIG. 7 shows a table relating to an exemplary method in accordance with aspects of the present invention.

FIG. 8 shows a flowchart of an exemplary method in accordance with aspects of the present invention.

### DETAILED DESCRIPTION

Aspects of the present invention relate generally to generating spherical visualizations and, more particularly, to generating spherical visualizations relating to AI lifecycle data. Aspects of the invention include a system for data and model governance across an AI lifecycle through a spherical view that includes bias detecting, such as distortion model or false positive or false negative, within a data set. Aspects of the invention include a system for data and model governance across an AI lifecycle through a spherical view that may include false negative rate ratio, false negative rate difference, false positive rate ratio, false positive rate difference, false discovery rate ratio, false discovery rate difference, false omission rate ratio, false omission rate difference, error rate ratio, and error rate difference. The data set may be, for example, AI model training data. According to aspects of the invention, the system for data and model governance may be configured to generate and display a spherical model having a spherical coordinate system showing data points, basis vectors, and data gradients, i.e., the rate of change of a metric or function with respect to changes within a data set, or the measure of change in AI model outputs based on a change in data set inputs. According to aspects of the invention, the system may be configured to normalize artificial intelligence model input data set, generate a basis vector based on the normalization, and determine a direction of the data set based on the basis vector and a normalized data set.

According to aspects of the invention, the system may include encoding a data point of the data set and converting the encoded data point into an angle on the spherical coordinate system to determine basis vector directions for data within the data set. The system may further include generating a spherical model comprising the basis vector and displaying the spherical model.

According to aspects of the invention, a spherical model may be used to visualize data distribution or model results for AI governance propose, such as the interpretation of business processing results, among the AI life cycle from model data set to facilitate data modeling processes. The process of converting an encoded data point into an angle on a spherical coordinate system involves mapping the high-dimensional data into a lower-dimensional representation suitable for data computation. This conversion is achieved by first encoding the data point using a specified encoding scheme, such as amplitude encoding or basis encoding. The encoded data is then transformed into spherical coordinates, where each data point is represented by a set of angles that define its position on a sphere. This transformation enables the determination of a basis vector direction for the data within the data set, facilitating subsequent data operations and visualizations in a spherical model. The use of spherical coordinates helps in leveraging the geometric properties of data states and enhances the interpretability of the data model. AI models may include unintended bias and unfairness that may inadvertently cause harm. AI models require risk assessment and management to ensure stability, resilience, and performance robustness. In a data preprocessing stage for supervised learning and unsupervised learning AI models, sample classification visualization may be achieved to avoid bias in data sets used to train AI models including identifying missing data samples. A spherical model may be used to visualize categorized data and identify possible data quality issues (such as false negative and false positive data) to avoid bias training results with respect to unique data samples within a data set. According to embodiments, a data gradient may be visualized in a spherical model so that the quality of training data may be judged before use. A spherical model may be used to visualize multiple training results or varying data sets to identify differences between data samples and data gradients. When visualized in a spherical model, similar data may be quickly identified to provide similarity decision support and data gradients may be identified to provide visual data support for business optimization.

According to aspects of the invention, attributes of an artificial intelligence model input data set may be normalized and expressed as a combination of numbers between 0 and 1. Normalizing may include scaling unique data points or values within the data set to a standardized range. For example, input data having three attributes of “ABC” may be defined based on basis vectors from 000 to 111, e.g., 010, 011, 100, etc. A basis vector of a data set may include a single data point or observation within the data set represented as a vector, wherein the single data point correlates to a plotted location on a three-dimensional coordinate system within a spherical model, and the data gradient of the data point correlates to direction of the vector. Input data may be mapped to spherical coordinates of a spherical model by generating a basis vector per input data, encoding data points of the input data, converting encoded data points into an angle on a spherical coordinate system to determine basis vector directions for input data within the data set, and displaying input data as data points on the spherical coordinate system. Encoding of data points within a data set may include representing categorical variables or non-numeric data as numerical values that can be used for analysis, AI, or machine learning tasks. Encoding may include: binary column encoding, i.e., labeling columns for categories of data such as 000, 100, 010, etc.; label encoding; ordinal encoding; frequency coding; target encoding; etc.

According to aspects of the invention, for each input data, the radius of a sphere shown on the spherical coordinate system may be increased by one, and normalization of an artificial intelligence model input data set may be performed including scale values of attributes of data to a specific range, e.g., between 0 and 1. Normalization may ensure that all features contribute equally to the analysis and prevent attributes with large scales from dominating the AI learning process. As a non-limiting example, a data set may include 1000 input data samples, 50 of which may be rounded to a value of 000. In this example, the height of the 000 basis vector is 0.05. In this manner, input data may be normalized as a plurality of basis vectors displayed on the spherical model, illustrating where data sampling may be missing, where bias is present, etc. In some embodiments, normalization may include color-coding basis vectors to indicate data distribution and further used for bias detection approach, such as distortion model or false positive and false negative data. According to embodiments, the method may include plotting data distribution on a distortion model on the spherical model to identify modifications or distortions of the data from an original state. This may include, for example, cosine similarity measurements between two basis vectors on the spherical model.

According to aspects of the invention, color-coding of basis vectors may be performed after normalization for data training results. The spherical model may include a spherical surface defined by height R (radius of the sphere) and having color-coding expressed as phase P. Data gradients may be visualized as vectors on the spherical model. Based on the basis vector or data gradient direction, gradient change may be measured to estimate the possibility of adversarial attacks or the need for additional model optimization. The spherical model may provide visualization of attributes per data set so that input data may be compared to one another and gaps within data sets may be identified based on the data sets or model training results. Similarly, because each data point within a data set is normalized on the spherical model, similar data points may be rapidly identified to aid in decision-making with respect to model training or input data, and data quality may be improved based on visualized data gradients.

According to aspects of the invention, a visualization model, such as a spherical model, may be built using a normalization process including a positioning calculation for an angle of a basic vector and location of the direction of the data based on the basic vector and a normalized result. Data may be normalized value points may be encoded based on binary basis vectors. For example, in a sample with three attributes A, B, and C, “000>” indicates that a sample in which the attributes A, B, and C are at the minimum value at the same time. “111>” may represent the sample in which the three attributes are at a maximum value at the same time based on the sample encoding, the encoding may be converted into an angle on polar coordinates thereby determining all basic vector directions. For any attributes, such as A, B, and C, referring to the nearest basis vector after normalization may allow for locating the direction of the data in polar coordinates. According to aspects of the invention, a number of samples may be superimposed along a basic vector direction, thereby increasing the radius of data samples in polar coordinates. That is, if numerous data samples are in the same direction, the larger the radius will be in set direction. However, when displayed on a spherical model, the radius of data points may be normalized such that all data points share the same radius range. According to aspects of the invention, color marking of data points and basic vectors may be used based on the type of data sample. As a non-limiting example, a phase ring may be used to distinguish and mark different results between data samples.

According to aspects of the invention, a spherical model may be used to provide a unified visualization method realizing data visualization for the entire life cycle of an AI model, including preproduction and production applications. Identifying global bias within a data set prior to training an AI model may facilitate the identification of whether there is bias caused by missing data in an original data set prior to training. For example, if there are apparent depressions, protrusions, or outliers on the spherical surface of the spherical model, data may be under-sampled or oversampled in certain areas, allowing data scientists to identify gaps in data and to analyze and process data samples. For supervised algorithms, a spherical model may facilitate identifying data quality issues, such as false positive and false negative data, prior to training in the AI model. In some embodiments, sample data used for AI model training may be labeled in advance such that when the data is visualized on a spherical model it may be color-coded for ease of identification. Data sample points may be identified as outliers, false positives, false negatives, etc., based on a comparison between other data points on the spherical model. For example, color coding of data points may result in portions of a data set color-coded as red and other portions of the data set color-coded as blue. Intermixed red and blue color-coded data sets may indicate the possibility of false positive or false negative data. The spherical model may display a color-marked sphere intuitively representing bias or discrimination results within various types of data and data gradient trends.

According to aspects of the invention, a spherical model may include a basis vector displayed having a color change on the spherical model between normalized data points 000 and 001, depicting a single data gradient attributable to attribute C of all attributes ABC. Similarly, a basis vector displayed having a color change on the spherical model between normalized data points 000 and 011, depicting data gradients attributable to attributes B and C of all attributes ABC. Color-coding of basis vectors may indicate or help establish boundaries of discriminative classification in an AI model such that, data scientists may use the spherical model to identify the need for clarity of boundaries before applying the AI model to a production environment. In this manner, adversarial attacks that may occur near boundaries may be prevented.

According to aspects of the invention, a spherical model may be configured to support intuitive comparison between spherical models of different data sets. In discrete two-dimensional displays, one-dimensional data gradients are shown on the side of 000, and the gradient change between 000 and 011 is limited by the expression of the two-dimensional plane, making it difficult to visualize data gradient changes. According to aspects of the invention, if the boundary of the classification on a certain data gradient, e.g., 000 to 010, is obscured or unclear in a first spherical model, a method of pattern analysis, such as a kernel method, may be used to reprocess and train the model. A new spherical model may be generated with a narrower border within the data gradient, missing data may be supplemented into the model, and the spherical model may be generated to depict the change in radius of the spherical model.

According to aspects of the invention, a spherical model may be configured to visualize supplemental data with respect to an original data set. Supplementing a data set may include applying the spherical model to a data set ABC, normalizing the data set, and displaying the data set on the spherical model. Sample points within the ABC data set may be visualized individually indicative of the consistency of an AI model's judgment results with respect to historical data. Similarly, sample points may serve as the basis for an AI model judgment. According to aspects of the invention, it may be desirous to modify AI model judgment and, based on color coding of data sets and data samples, adjust direction to optimize suggestions to an AI model, thereby adjusting AI model judgment.

According to aspects of the invention, a spherical model may be configured to receive interactions such as “drag and drop” of basis vectors and data points to modify the observation of data. Additionally, the spherical model may be configured to allow for discrete or continuous scaling, including the processing of data points through mathematical methods near spherical coordinates on the spherical model that does not have sample data points. Scaling may include receiving user input to change the scale of the spherical model and generating new instructions to re-render the spherical model based on the user input to change the scale. Additionally, the spherical model may be configured to allow for the supplementation of discrete data point values such that the spherical surface of the spherical model may display a smoother visualization of data points.

In this manner, aspects of the invention provide comprehensive visualization through a spherical view to enable comprehensive representation of complex data gradients allowing for intuitive visualization of high dimensional data. Similarly, aspects of the present invention provide a unified view for AI governance-related processes throughout an AI model lifecycle, thereby eliminating the need for different data views at different life cycle stages and promoting consistency in decision-making based on data sets and data gradients. Similarly, aspects of the present invention facilitate encoded data arrangement on the spherical surface of this spherical model through encoding methods or numerical control theory, improving the interpretability of the data and enhancing decision-making in various stages of an AI model life cycle.

Implementations of the invention are necessarily rooted in computer technology. For example, converting an encoded data point into an angle on a spherical coordinate system to determine basis vector directions for data within the data set, generating a basis vector based on the normalization, and generating a spherical model comprising the basis vector and cannot be performed in the human mind. In particular, given the large size of data sets and complexity of samples, it would be impossible to perform the steps of encoding all the data points of the data set, converting all encoded data points into angles on a spherical coordinate system to determine basis vector directions for data within the data set, generating basis vectors based on the normalization, and generating instructions to render a spherical model comprising the basis vectors in the human mind or performing said steps on pen-and-paper.

Implementations of invention may be used to view a spherical model and perform computer-based interactions such as “drag and drop” of basis vectors and data points to redirect the direction of a data set or modify observations of data. For example, user input at an end-user device, such as a keyboard and mouse of a computer, may include manipulation of basis vectors and data points on the spherical model to redirect the direction of a data set or modify observations of data. In response to user input, the spherical model may generate and provide instructions to the end-user device to dynamically render or re-render the spherical model based on user input to improve visualization of AI model training data sets. In this manner, embodiments are configured to improve the technical field of AI model explainability by providing a computer rendered, interactive three-dimensional spherical model configured to depict an understanding of an AI model or data set, describe an AI model development processes, or describe the operational methods of AI models or systems. Accordingly, embodiments described herein are necessarily rooted in computer technology and cannot be performed on pen and paper, are not methods of organizing human activity, and cannot performed in the human mind.

Additionally, implementations of the invention overcome deficiencies in current discrete displays of two-dimensional data. For example, one-dimensional data gradients are typically shown on the side of 000. In a two-dimensional data display, the gradient change between 000 and 011 is limited by the expression of the two-dimensional plane making it difficult to visualize data gradient changes. Embodiments are configured to improve the technical field of AI model explainability and data visualization by providing an interactive three-dimensional spherical model configured to depict an understanding of an AI model, describe an AI model development processes, and describe the operational methods of AI models or systems.

Implementations of invention may be used to view a spherical model on an end-user device to identify bias within a data set used as input to an AI model or for supervised or unsupervised training of an AI model. The spherical model may be used to identify and eliminate unintended bias and unfairness in a data set that may inadvertently cause harm. In this manner, implementations of invention may be used to view a spherical model and perform computer-based interactions models to perform risk assessment and management of data sets to ensure stability, resilience, and performance robustness when used in AI models.

In embodiments, a computer-implemented method may include normalizing, by the processor set, an artificial intelligence model input data set; encoding, by the processor set, a data point of the data set; converting, by the processor set, the encoded data point into an angle on a spherical coordinate system to determine a basis vector direction for the data within the data set; generating, by the processor set, a basis vector comprising the encoded data point based on the angle and the normalization; and generating, by the processor set, instructions to render a spherical model comprising the basis vector, wherein the instructions are configured to cause a client device to render the spherical model. Aspects of the present invention improve the process of visualizing basis vectors on a spherical model to facilitate the identification of bias, false positives, false negatives, or missing data within an artificial intelligence model input data set.

In embodiments, the computer-implemented method may include plotting data distributions and bias cases comprising distortion models, false positive data, false negative data, and missing data within the data set on the spherical model Aspects of the present invention improve the process of visualizing false positive and false negative data within a data set to avoid bias training results when using an artificial intelligence model.

In embodiments, the computer-implemented method may include determining data markers based on a type of data point within the data set; and applying data markers to the data set. Aspects of the present invention improve the process of visualizing types of data within a data set by identifying and marking unique data points based on a classification, type, etc.

In embodiments, the computer-implemented method may include data markers that are color-coded data points on the spherical model. Aspects of the present invention improve the process of visualizing types of data within a data set by clearly indicating data point classes, types, etc., with a classification or type-specific color when displayed on a spherical model.

In embodiments, the computer-implemented method may include data markers that are indicative data distributions and bias cases comprising distortion model, false positive data, false negative data, or missing data. Aspects of the present invention improve the process of visualizing types of data within a data set by clearly indicating false positive and false negative data with specific colors when displayed on a spherical model.

In embodiments, the computer-implemented method may include determining a direction of the artificial intelligence model input data set based on the basis vector and a normalized data set; and redirecting the direction of the data set based on user input. Aspects of the present invention improve the technical field of AI model explainability by providing a computer rendered, interactive three-dimensional spherical model configured to depict an understanding of an AI model or data set, describe an AI model development processes, or describe the operational methods of AI models or systems.

In embodiments, the computer-implemented method may include scaling the spherical model based on user input. Aspects of the present invention improve the technical field of AI model explainability by allowing for discrete or continuous computer-based scaling, including the processing of data points through mathematical methods near spherical coordinates on the spherical model that may not have sample data points.

In embodiments, the computer-implemented method may include displaying a bias on the spherical model. Aspects of the present invention improve the process of visualizing bias within a data set to avoid bias training results with respect to unique data samples within a data set.

In embodiments, a computer program product may include one or more computer readable storage media having program instructions collectively stored on the one or more computer readable storage media. The program instructions are executable to: normalize an artificial intelligence model input data set; encode a data point of the data set; convert the encoded data point into an angle on a spherical coordinate system to determine a basis vector direction for the data within the data set; generate a basis vector comprising the encoded data point based on the angle and the normalization; and generate instructions to render a spherical model comprising the basis vector, wherein the instructions are configured to cause a client device to render the spherical model. Aspects of the present invention improve the process of visualizing basis vectors on a spherical model to facilitate the identification of bias, false positive, false negative, or missing data within an artificial intelligence model input data set.

In embodiments, the computer program product may include plotting data distributions and bias cases comprising distortion models, false positive data, false negative data, and missing data within the data set on the spherical model. Aspects of the present invention improve the process of bias visualizing such as distortion model, false positive, false negative data, or missing data within a data set to avoid bias training results when using an artificial intelligence model.

In embodiments, the computer program product may include determining data markers based on a type of data point within the data set; and applying data markers to the data set. Aspects of the present invention improve the process of visualizing types of data within a data set by identifying and marking unique data points based on a classification, type, etc.

In embodiments, the computer program product may include data markers that are color-coded data points on the spherical model. Aspects of the present invention improve the process of visualizing types of data within a data set by clearly indicating data point classes, types, etc., with a classification or type-specific color when displayed on a spherical model.

In embodiments, the computer program product may include data markers that are indicative of data distributions and bias cases comprising distortion model, false positive data, false negative data, or missing data. Aspects of the present invention improve the process of visualizing types of data within a data set by clearly indicating false positive and false negative data with specific colors when displayed on a spherical model.

In embodiments, the computer program product may include determining a direction of the artificial intelligence model input data set based on the basis vector and a normalized data set; and redirecting the direction of the data set based on user input. Aspects of the present invention improve the technical field of AI model explainability by providing a computer rendered, interactive three-dimensional spherical model configured to depict an understanding of an AI model or data set, describe an AI model development processes, or describe the operational methods of AI models or systems.

In embodiments, the computer program product may include scaling the spherical model based on user input. Aspects of the present invention improve the technical field of AI model explainability by allowing for discrete or continuous computer-based scaling, including the processing of data points through mathematical methods near spherical coordinates on the spherical model that may not have sample data points.

In embodiments, the computer program product may include displaying a bias on the spherical model. Aspects of the present invention improve the process of visualizing bias within a data set to avoid bias training results with respect to unique data samples within a data set.

In embodiments, a system may include a processor set, one or more computer readable storage media, and program instructions collectively stored on the one or more computer readable storage media. The program instructions are executable to normalize an artificial intelligence model input data set; encode a data point of the data set; convert the encoded data point into an angle on a spherical coordinate system to determine a basis vector direction for the data within the data set; generate a basis vector comprising the encoded data point based on the angle and the normalization; and generate instructions to render a spherical model comprising the basis vector, wherein the instructions are configured to cause a client device to render the spherical model. Aspects of the present invention improve the process of visualizing basis vectors on a spherical model to facilitate the identification of bias, false positive, false negative, or missing data within an artificial intelligence model input data set.

In embodiments, the system may include plotting data distributions and bias cases comprising distortion models, false positive data, false negative data, and missing data within the data set on the spherical model. Aspects of the present invention improve the process of bias visualizing such as distortion model, false positive, false negative data, or missing data within a data set to avoid bias training results when using an artificial intelligence model.

In embodiments, the system may include determining data markers based on a type of data point within the data set; and applying data markers to the data set. Aspects of the present invention improve the process of visualizing types of data within a data set by identifying and marking unique data points based on a classification, type, etc.

In embodiments, the system may include data markers that are color-coded data points on the spherical model. Aspects of the present invention improve the process of visualizing types of data within a data set by clearly indicating data point classes, types, etc., with a classification or type-specific color when displayed on a spherical model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as spherical visualization code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

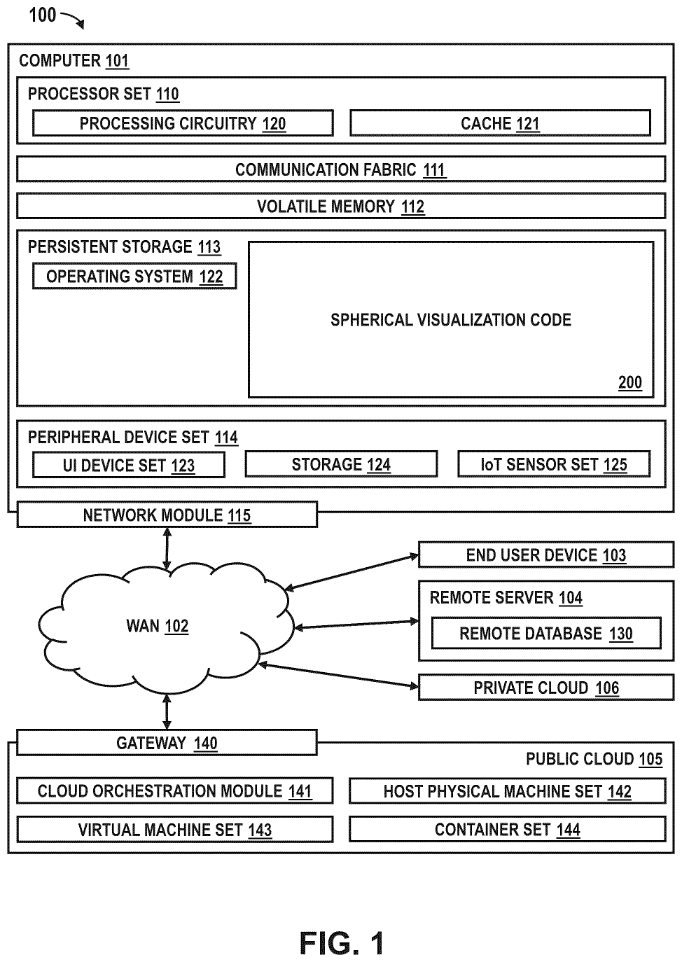

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this manner, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

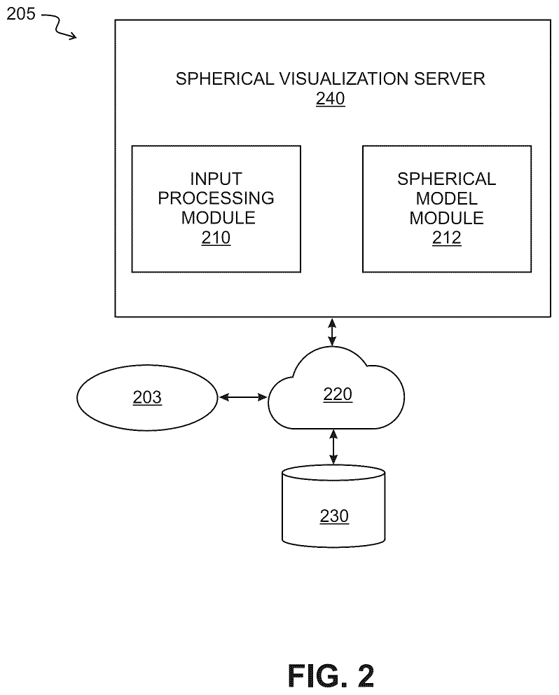

FIG. 2 shows a block diagram of an exemplary environment 205 in accordance with aspects of the invention. In embodiments, environment 205 includes spherical visualization server 240, corresponding to computer 101 of FIG. 1, including or in operable communication with input processing module 210 and a spherical model module 212, collectively corresponding to the spherical visualization code of block 200, as in FIG. 1.

The input processing module 210 may be configured to normalize a data set, such as by scaling unique data points or data values within the data set to a standardized range. In this manner, embodiments are configured to normalize a data set via standardization, z-score normalization, or min-max scaling by scaling data points to a fixed range between 0 and 1. The input processing module 210 may encode a data point of the data set. In embodiments, this is done by representing categorical variables or non-numeric data as numerical values that can be used for analysis, AI, or machine learning tasks, such as by binary column encoding. The input processing module 210 may be configured to convert an encoded data point into an angle on a spherical coordinate system to determine basis vector directions for data within the data set. In embodiments, this is done by mapping encoded data to a three-dimensional coordinate system of the spherical model, wherein each dimension of the coordinate system represents a different attribute of the encoded data. In some embodiments, different attributes of encoded data may each have respective vectors (data gradients), which may be averaged to form the basis vector. Normalizing the data set, as performed by the input processing module 210, ensures that encoded data mapped to the three-dimensional coordinate system of the spherical model lie on a unit sphere, i.e., each basis vector has an identical length.

The spherical model module 212 may be configured to generate a basis vector based on the normalization, determine a direction of the data set based on the basis vector and a normalized data set, generate a spherical model comprising the basis vector, and display the spherical model, such as on EUD 203, corresponding to EUD 103 of FIG. 1. Generating a basis vector may include plotting the location of a data point on a three-dimensional coordinate system within a spherical model, where the data gradient of the data point correlates to the direction of the vector. Each basis vector may include a magnitude, i.e., the length of the basis vector when plotted on a spherical model, and a direction, i.e., a line from the origin of the spherical model to a terminal point indicative of the data point on the spherical model. Determining the direction of the data set may include identifying the direction of a basis vector or averaging the direction of multiple basis vectors relating to each data point within a data set. For example, the direction of the data set may be determined by plotting a line from the origin of the spherical model to the data point on the spherical model. As another example, the direction of the data set may be determined by subtracting the spherical coordinates of the origin of the spherical model from the spherical coordinates of the data point when plotted on the spherical model. In this manner, embodiments are configured to determine the direction of the data set based on the basis vector and a normalized data set. The direction of a data set may be indicative of similarities between unique data points within a data set. Similarly, the direction of a data set may be used to identify outliers indicative of bias within a data set. For example, the spherical model module 212 may be configured to generate a spherical model, including the basis vector, by plotting basis vectors on a three-dimensional coordinate system of the spherical model. In embodiments, the spherical model module 212 may be configured to apply data markers to a data set, e.g., color-coding data points or basis vectors, based on a type of data sample in a data set, e.g., based on data samples having data gradient changes between 000 and 011. In this manner, embodiments are configured to determine data markers based on a type of data sample within the data set and apply data markers to the data set. In embodiments, data markers may be color-coded, e.g., a first data set may be color-coded red, a second data set may be color-coded blue, and each may be shown as red and blue data points and red and blue basis vectors on the spherical model. In embodiments, data markers may be indicative of false positive and false negative data. In embodiments, data markers indicate that a data point is missing, or a data point is an outlier from a group of other data points displayed on the spherical model.

In embodiments, the environment 205 includes a database 230 in operable communication with the spherical visualization server 240 over WAN 220 corresponding to WAN 102 of FIG. 1. The database 230, corresponding to remote server 104 or remote database 130 of FIG. 1, may store data imported into the system such as AI model training data sets. EUD 203 may be used, for example, to view the spherical model and perform interactions such as “drag and drop” of basis vectors and data points to redirect the direction of a data set or modify observations of data, or interactions such as discrete or continuous scaling including standardization, z-score normalization or standardization, or min-max scaling. For example, user input at the EUD 203 may include manipulation of basis vectors and data points to redirect the direction of a data set or modify observations of data, such as via a mouse and keyboard input or touch inputs received by EUD 203. In response to user input, the spherical visualization server 240 may generate and provide instructions to EUD 203 to dynamically render or re-render the spherical model based on user input to improve visualization of AI model training data sets. In this manner, embodiments are configured to scale the spherical model based on user input. In this manner, embodiments are configured to improve the technical field of AI model explainability and data visualization by providing an interactive three-dimensional spherical model configured to depict an understanding of an AI model, describe an AI model development processes, and describe the operational methods of AI models or systems. Accordingly, embodiments described herein are necessarily rooted in computer technology and cannot be performed on pen and paper, are not methods of organizing human activity, and cannot performed in the human mind.

In embodiments, the spherical visualization server 240 of FIG. 2 comprises input processing module 210 and spherical model module 212, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The spherical visualization server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

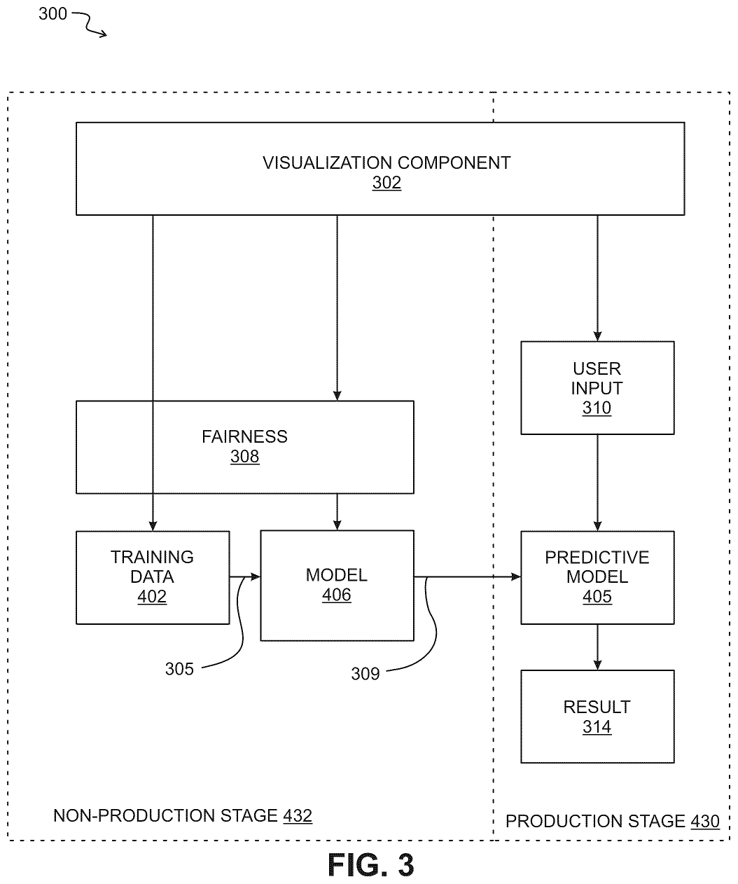

FIG. 3 shows a block diagram of an exemplary method 300 in accordance with aspects of the present invention. Steps of the method may be carried out in the environment of FIG. 2 and are described with reference to elements depicted in FIG. 2. Visualization component 302 may correspond to the spherical visualization server 240 of FIG. 2 and the code of block 200 of FIG. 1 and may include the input processing module 210 and the spherical model module 212 of FIG. 2. Visualization component 302 may include an interactive spherical model rendered on a computing device which may receive user input 310 to detect bias based on fairness 308 within a data set. As a non-limiting example, visualization component 302 may include a spherical model and a plurality of basis vectors associated with a data set plotted on the spherical model. A model 406, such as an AI model, may be trained from training data 402, such as AI model training data, which may inherently include bias. Bias detection may be visualized as outliers, false positives, false negatives, missing data, etc., when rendered on a spherical model. Training data 402 may be processed by the input processing module 210 of FIG. 2, including normalization, encoding, and conversion of an encoded data point into an angle on a spherical coordinate system to determine basis vector. The model 406 in a non-production stage 432 may receive training data 402. Training data 402 may be used to build model 406 and predictive model 405 as outputs. Once model 406 has been verified as deployable in non-production stage 432, then model 406 will undergo deployment 309 to production stage 430 as predictive model 405. The predictive model 405 may be built using predictive model building techniques, including determining predictive outputs, training data 402 collection and pre-processing, employing model(s) or algorithm(s), training the model using the training data 402, and tuning and model evaluation to improve accuracy. Building the predictive model 405 may include validation 305 i.e., assessing the performance and reliability of the predictive model 405, and deployment 309 in a production stage 430. The spherical model may be generated by the spherical model module 212 of FIG. 2 based on the training data 402 and user input 310 interaction with the visualization component 302. The result 314 may include bias indicators shown as plotted basis vectors associated with a data set which may indicate fairness 308 within a data set such as training data 402 or user input 310. In this manner, bias indicators, when considering AI model governance, may be detected in an AI model pre-training (non-production) stage or post-training (production) stage through the use of the disclosed spherical model.

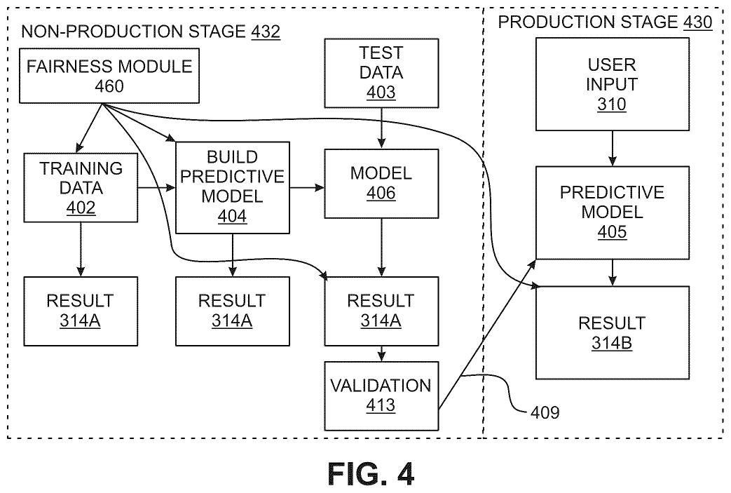

FIG. 4 shows a block diagram of an exemplary environment in accordance with aspects of the present invention. An AI model in a non-production stage 432 may receive training data 402. Training data 402, depicted as training data 402 in FIG. 3, may be used to build predictive model 404, such as an AI model depicted as model 406 or predictive model 405 in FIG. 3. The model 406 may be built using predictive model building techniques, including determining predictive outputs, training data 402 collection and pre-processing, employing model(s) or algorithm(s), training the model using the training data 402, and tuning and model evaluation to improve accuracy. Test data 403 may be input into model 406 to generate result 314A. In a non-production stage 432, results 314A, i.e., predictive outputs generated by the model 406, may include bias originating from the training data 402 when the data used to train the model 406 is not representative of the population it aims to classify or predict. Similarly, in a production stage 430, results 314B, i.e., predictive outputs generated by the predictive model 405, may include bias originating from the user input 310 when the user input 310 used to train the predictive model 405 is not representative of the population it aims to classify or predict. Results 314A and results 314B may include statistical properties, such as missing data samples, contributing to indirect bias, such as bias originating from training data 402 or user input 410. In some embodiments, an AI model in a non-production stage 432 may include a fairness monitor that may be a framework of data handling rules used to ensure that the predictions or decisions made by the AI model are fair with respect to statistical properties. The fairness monitor may be configured to mitigate biases and promote equitable results 314B via the framework of data handling rules for all individuals or groups affected by the system's predictions or decisions. According to embodiments, fairness module 460 (artificial intelligence fairness) may be a plurality of pre-processing, in-processing, and post-processing algorithms configured for pre-processing, in-processing, and post-processing of training data 402, results 314A, results 314B and in-processing of the build predictive model 404. Fairness module 460 may be configured to evaluate and measure fairness in the context of individual fairness, group fairness, individual bias, and group bias. Building the predictive model 404 may include validation 413 i.e., assessing the performance and reliability of the model 406 and deployment 409 in a production stage 430, depicted as validation 305 in FIG. 3. In embodiments, validation 413 may be based on the pre-processing, in-processing, and post-processing of training data 402, results 314A, results 314B and in-processing of the build predictive model 404.

An AI model in a production stage 430 may be configured to evaluate or predict new data points, based on user input 310. In some embodiments, user input 310 may be similar in features to training data 402 but lacks data attribute labeling, identification, classification, etc. User input 310 may be processed by the predictive model 405 to generate results 314B generated by the predictive model 405 including individual bias originating from the user input 310 used in the predictive model 405. Individual bias may be bias arising from attributes of unique data points within the user input 310. The AI model in a production stage 430 implements a bias module, such as fairness module 460, using individual detect bias mechanisms to detect bias related with user input 310, apply constraints to the AI model to encourage fair predictive modeling, etc. The bias module may receive results 314B which may include group bias identified by the bias module similar to statistical properties contributing to indirect bias, as in the non-production stage 432. The bias module may identify group bias based on statistical analysis, using fairness metrics and measures, data comparison, audits, etc. The bias module may identify group bias and generate an alert indicative of a bias violation. The bias module may be in operable communication with a scoring endpoint, which may provide an interactive endpoint configured to allow users to receive the alert indicative of a bias violation or allow users to provide new user input 310 to the predictive model 405 to results 314B.

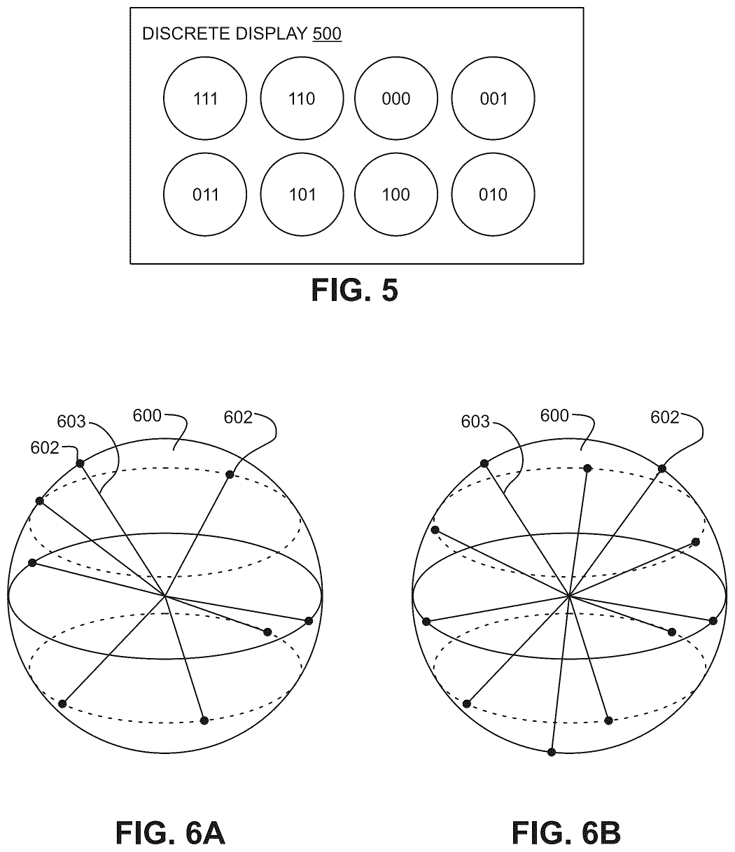

FIG. 5 shows a diagram of an exemplary method in accordance with aspects of the present invention. FIG. 5 shows a discrete display 500 of two-dimensional data. In embodiments, one-dimensional data gradients are shown on the side of 000. In a two-dimensional data display, the gradient change between 000 and 011 is limited by the expression of the two-dimensional plane making it difficult to visualize data gradient changes.

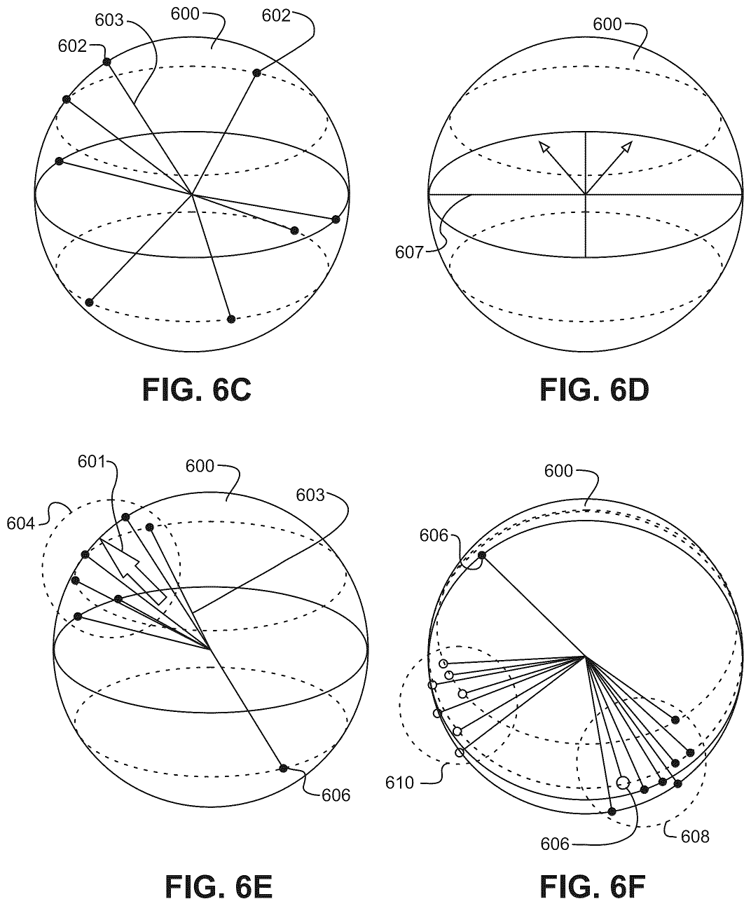

FIG. 6A-6H depict examples of a spherical model 600 as rendered by the spherical visualization server 240 of FIG. 2 or the visualization component 302 of FIG. 3, both of which may include the input processing module 210 and a spherical model module 212, collectively corresponding to the spherical visualization code of block 200 of FIG. 1. The spherical model 600 of FIG. 6A-6H may be an interactive spherical model rendered on a computing device and may receive user interaction input, for example through EUD 103 of FIG. 1, to identify bias within a data set, including fairness 308 and group bias 422 of FIG. 4. User interaction input may take the form of computer-based interactions, such as via mouse and keyboard, including “drag and drop” functionality of basis vectors and data points to redirect the direction of a data set or modify observations of data as depicted on the spherical model 600. Similarly, user interactive input may include discrete or continuous scaling, including the processing of data points through mathematical methods near spherical coordinates on the spherical model that does not have sample data points. In this manner, user interactive input may change the scale of the spherical model by generating new instructions to re-render the spherical model based on the user interactive input to change the scale. Additionally, the spherical model may be configured to allow for user interactive input as supplementation of discrete data point values such that the spherical surface of the spherical model may display a smoother visualization of data points. The spherical model 600 may depict result 314 of FIG. 3, including bias indicators shown as plotted basis vectors associated with a data set indicating bias. FIG. 6A-6H depict examples of a spherical model 600 including the depiction of data gradient changes that are not visualized in a discrete display of two-dimensional data, such as the discrete display 500 of FIG. 5. As shown in FIG. 6A-6H, data gradient changes may be intuitively shown as a plurality of data points 602 and corresponding basis vectors 603, corresponding to basis vectors 306 of FIG. 3.

FIG. 6A shows an example of a spherical model 600 in accordance with aspects of the present invention. Spherical model 600 may include a plurality of data points 602 and corresponding basis vectors 603 from within a data set. A data set may include data points 602 and corresponding basis vectors 603 encoded as binary basis vectors having attributes, e.g., A, B, and C, wherein each data point has a numerical value between 0 and 1 indicative of the value of the attributes A, B, and C. For example, binary basis vectors having attributes may be identified as 000, 110, 010, etc.

FIG. 6B shows an example of a spherical model 600 in accordance with aspects of the present invention. Spherical model 600 may include a plurality of data points 602 and corresponding basis vectors 603 from within a data set. A data set may include data points 602 and corresponding basis vectors 603 encoded as binary basis vectors having attributes, e.g., A, B, C, and D, wherein each data point has a numerical value between 0 and 1 indicative of the value of the attributes A, B, C, and D. For example, binary basis vectors having attributes may be identified as 0100, 1100, 0101, etc.

FIG. 6C shows an example of a spherical model 600 in accordance with aspects of the present invention. Spherical model 600 may include a plurality of data points, depicted as data points 602 in FIG. 6A, and corresponding basis vectors, depicted as basis vectors 603 in FIG. 6A. A data set 604 may include data points and corresponding basis vectors. The spherical model 600 may also include outlier data points indicative of bias within the data set 604 when displayed on the spherical model 600. In this manner, embodiments are configured to display the bias on the spherical model.

FIG. 6D shows an example of a spherical model 600 in accordance with aspects of the present invention. Spherical model 600 may include a plurality of data points, depicted as data points 602 in FIG. 6A, and corresponding basis vectors, depicted as basis vectors 603 in FIG. 6A. A data set, depicted as data set 604 in FIG. 6B may include data points and corresponding basis vectors encoded as binary basis vectors having attributes, wherein the encoded basis vectors are converted into an angle on a spherical coordinate system 607 to determine a basis vector direction for each data point.

FIG. 6E shows an example of a spherical model 600 in accordance with aspects of the present invention. Spherical model 600 may include a plurality of data points, depicted as data points 602 in FIG. 6A, and corresponding basis vectors, depicted as basis vectors 603 in FIG. 6A. A data set 604 may include data points and corresponding basis vectors. A direction of the data set may be determined based on the direction of a basis vector 603 or averaging the direction of multiple basis vectors 603 relating to each data point within a data set 604. Direction 601 may be averaged basis vectors 603 of the data set 604, and may indicate similarities within the data set 604 that are distinct from an outlier data point 606, thereby facilitating the identification of bias within the data set 604. The spherical model 600 may also include outlier data points 606 indicative of bias within the data set 604 when displayed on the spherical model 600. In this manner, the spherical model 600 may depict bias between data points.

FIG. 6F shows an example of a spherical model 600 in accordance with aspects of the present invention. Spherical model 600 may include a plurality of data points, depicted as data points 602 in FIG. 6A, and corresponding basis vectors, depicted as basis vectors 603 in FIG. 6A. A data set 604, depicted as data set 604 in FIG. 6E, may include data points and corresponding basis vectors. The data set 604 may include a first plurality of color-coded data points 608 and a second plurality of color-coded 610 data points. Outlier data points 606, such as false positive or false negative data, may be plotted to and displayed on the spherical model and identifiable as bias within the first. In this manner, the spherical model 600 may depict bias between data sets.

FIG. 6G and 6H show examples of spherical models 600 in accordance with aspects of the present invention, wherein the spherical models 600 depict a first AI model's processing of a data set similar to data set 604 depicted in FIG. 6B and a second AI model's processing of the same data set. As depicted in FIG. 6G and 6H, the first and second AI model display data from a first plurality of color-coded data points 608, corresponding to the first plurality of color-coded data points 608 in FIG. 6F, and a second plurality of color-coded 610 data points corresponding to the second plurality of color-coded data points 610 in FIG. 6F. As depicted in FIG. 6G and 6H, spherical models 600 may be compared to one another to identify differences quickly and easily, such as by comparing the relative positions of the first plurality of color-coded data points 608 and the second plurality of color-coded data points 610 on the spherical models.

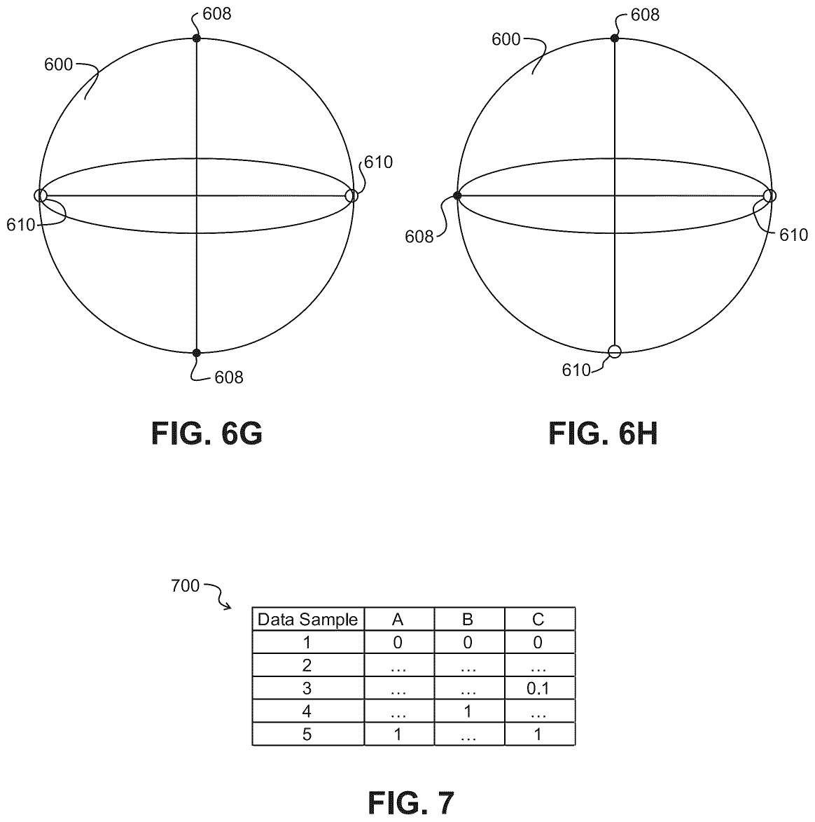

FIG. 7 shows a table 700 relating to an exemplary method in accordance with aspects of the present invention. FIG. 7 depicts data samples from a data set, such as data set 304 of FIG. 3, and corresponding attributes that have been normalized and expressed as a combination of numbers between 0 and 1, or null. Normalizing may include scaling unique data points or values within the data set to a standardized range. As depicted in FIGS. 2 and 3, a data set 304 of FIG. 3 may be processed by the input processing module 210 of FIG. 2, including normalization, encoding, and conversion of an encoded data point into an angle on a spherical coordinate system to determine basis vector 306 as in FIG. 3. For example, input data having three attributes of “ABC” may be defined based on basis vectors from 000 to 111, e.g., 010, 011, 100, etc.

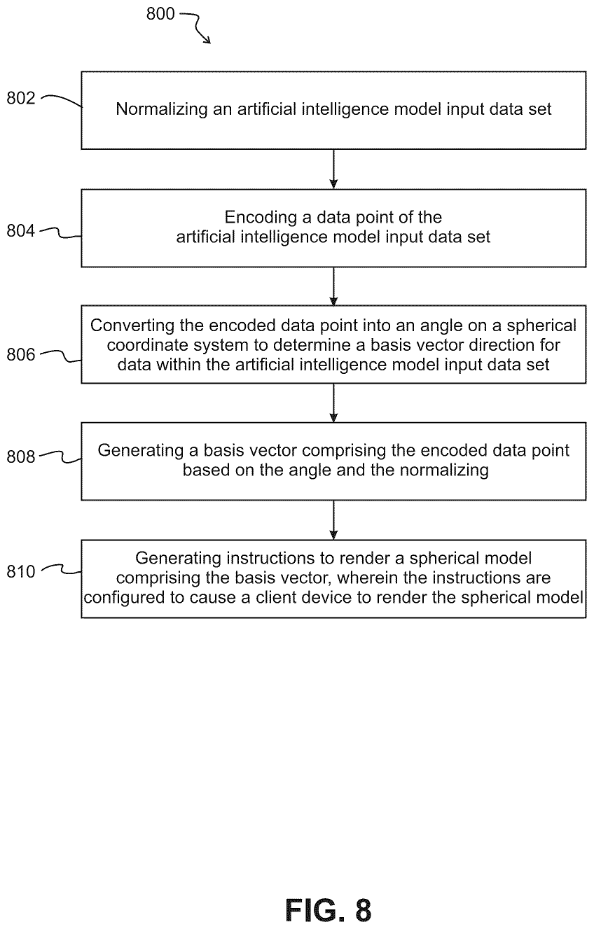

FIG. 8 shows a flowchart 800 of an exemplary method in accordance with aspects of the present invention. In step 802, the method may include normalizing an artificial intelligence model such as model 406 or predictive model 405, training data 402, result 314A or 314B, or training data 402 or user input 310 of FIG. 4, via the input processing module 210 of FIG. 2. In step 804, the method may include encoding a data point of the data set via the input processing module 210 of FIG. 2. In step 806, the method may include converting an encoded data point into an angle on a spherical coordinate system to determine basis vector directions for data within the data set via the input processing module 210 of FIG. 2. In step 808, the method may include generating a basis vector comprising the encoded data point based on the normalization spherical model module 212. In step 810, the method may include generating instructions to render a spherical model comprising the basis vector, wherein the instructions are configured to cause a client device to render the spherical model via the spherical model module 212 of FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
normalizing, by a processor set, an artificial intelligence model input data set;
encoding, by the processor set, a data point of the artificial intelligence model input data set;
converting, by the processor set, the encoded data point into an angle on a spherical coordinate system to determine a basis vector direction for data within the artificial intelligence model input data set;
generating, by the processor set, a basis vector comprising the encoded data point based on the angle and the normalizing; and
generating, by the processor set, instructions to render a spherical model comprising the basis vector, wherein the instructions are configured to cause a client device to render the spherical model.

2. The computer-implemented method of claim 1, further comprising:
plotting data distributions and bias cases comprising distortion models, false positive data, false negative data, and missing data within the artificial intelligence model input data set on the spherical model.

3. The computer-implemented method of claim 1, further comprising:
determining data markers based on a type of data point within the artificial intelligence model input data set; and
applying data markers to the artificial intelligence model input data set.

4. The computer-implemented method of claim 3, wherein the data markers are color-coded data points on the spherical model.

5. The computer-implemented method of claim 3, wherein the data markers are indicative of data distributions and bias cases comprising distortion model, false positive data, false negative data, or missing data.

6. The computer-implemented method of claim 1, further comprising:
determining a direction of the artificial intelligence model input data set based on the basis vector and a normalized data set; and
redirecting the direction of the artificial intelligence model input data set based on user input.

7. The computer-implemented method of claim 1, further comprising scaling the spherical model based on user input.

8. The computer-implemented method of claim 1, further comprising displaying a bias on the spherical model.

9. A computer program product comprising one or more computer readable storage media having program instructions collectively stored on the one or more computer readable storage media, the program instructions executable to:
normalize an artificial intelligence model input data set;
encode a data point of the artificial intelligence model input data set;
convert the encoded data point into an angle on a spherical coordinate system to determine a basis vector direction for data within the artificial intelligence model input data set;
generate a basis vector comprising the encoded data point based on the angle and the normalizing; and
generate instructions to render a spherical model comprising the basis vector, wherein the instructions are configured to cause a client device to render the spherical model.

10. The computer program product of claim 9, wherein the program instructions are executable to: plot data distributions and bias cases comprising distortion models, false positive on the spherical model.

11. The computer program product of claim 9, wherein the program instructions are executable to:
determine data markers based on a type of data point within the artificial intelligence model input data set; and
apply data markers to the artificial intelligence model input data set.

12. The computer program product of claim 11, wherein the data markers are color-coded data points on the spherical model.

13. The computer program product of claim 11, wherein the data markers are indicative of data distributions and bias cases comprising distortion model, false positive data, false negative data, or missing data.

14. The computer program product of claim 9, wherein the program instructions are executable to:
determine a direction of the artificial intelligence model input data set based on the basis vector and a normalized data set; and
redirect the direction of the artificial intelligence model input data set based on user input.

15. The computer program product of claim 9, wherein the program instructions are executable to: scale the spherical model based on user input.

16. The computer program product of claim 9, wherein the program instructions are executable to: display a bias on the spherical model.

17. A system comprising:
a processor set, one or more computer readable storage media, and program instructions collectively stored on the one or more computer readable storage media, the program instructions executable to:
normalize an artificial intelligence model input data set;
encode a data point of the artificial intelligence model input data set;
convert the encoded data point into an angle on a spherical coordinate system to determine a basis vector direction for the data within the artificial intelligence model input data set;
generate a basis vector comprising the encoded data point based on the angle and the normalizing; and
generate instructions to render a spherical model comprising the basis vector, wherein the instructions are configured to cause a client device to render the spherical model.

18. The system of claim 17, wherein the program instructions are executable to:
plot data distributions and bias cases comprising distortion models, false positive data, false negative data, and missing data within the artificial intelligence model input data set on the spherical model.

19. The system of claim 17, wherein the program instructions are executable to:
determine data markers based on a type of data point within the artificial intelligence model input data set; and
apply data markers to the artificial intelligence model input data set.

20. The system of claim 19, wherein the data markers are color-coded data points on the spherical model.
